(19) United States
(12) Patent Application Publication
(10) Pub. No.: US 2010/0109552 A1
(43) Pub. Date: May 6, 2010

(54) Light Dimmer Circuit

(76) Inventor: Rob Pomponio, Apple Valley, CA (US)

Correspondence Address: MUSKIN & CUSICK LLC, 100 West Main Street, SUITE 205, Lansdale, PA, 19446, US

(21) Appl. No.: 12/261,897

(22) Filed: Oct. 30, 2008

(51) Int. Cl. H05B 37/02

(52) U.S. Cl. 315/291

(57) ABSTRACT

A light dimmer circuit for use with light emitting diodes. Light emitting diodes (LEDs) are connected in parallel with capacitors, which are connected in parallel with LED drivers. The light dimmer circuit is capable of achieving a wide range of power levels to the LEDs.

### BACKGROUND OF THE INVENTION

1. Field of the Invention

The present inventive concept relates to a system and method for implementing a light dimmer circuit.

2. Description of the Related Art

Light dimmer circuits are known in the art. Lights that use light emitting diodes (LEDs) instead of conventional lights bulbs are sometimes preferred for a number of reasons, for example they may consume less power. Prior art dimmer circuits that are used to power LEDs can subject the LEDs to flicker.

What is needed is a light dimmer circuit that would reduce flicker and allow the dimmer to dim the LEDs gradually to the full off position.

### SUMMARY OF THE INVENTION

It is an aspect of the present general inventive concept to provide an improvement to light dimmer circuits.

The above aspects can be obtained by an apparatus that includes (a) a dimmer connected to a line voltage; (b) a transformer connected to an output of the dimmer; (c) a first LED driver connected to the transformer, the first LED driver having a first pair of driver terminals; (d) a first capacitor connected in parallel to the first pair of driver terminals; (e) a second LED driver connected to the transformer, the second LED driver having a second pair of driver terminals; (f) a second capacitor connected in parallel to the second pair of driver terminals; (g) a first string of LEDs connected in parallel to the first capacitor; and (h) a second string of LEDs connected in parallel to the second capacitor.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is a circuit diagram illustrating an exemplary layout of a light dimmer circuit, according to an embodiment; and

FIG. 2 is a circuit diagram illustrating a second layout of a light dimmer circuit, according to an embodiment.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

The general inventive concept relates to a light dimmer circuit that uses one or more capacitors in order to allow for a lower level (even 0%) of power output to LEDs. A standard incandescent light dimmer can be used.

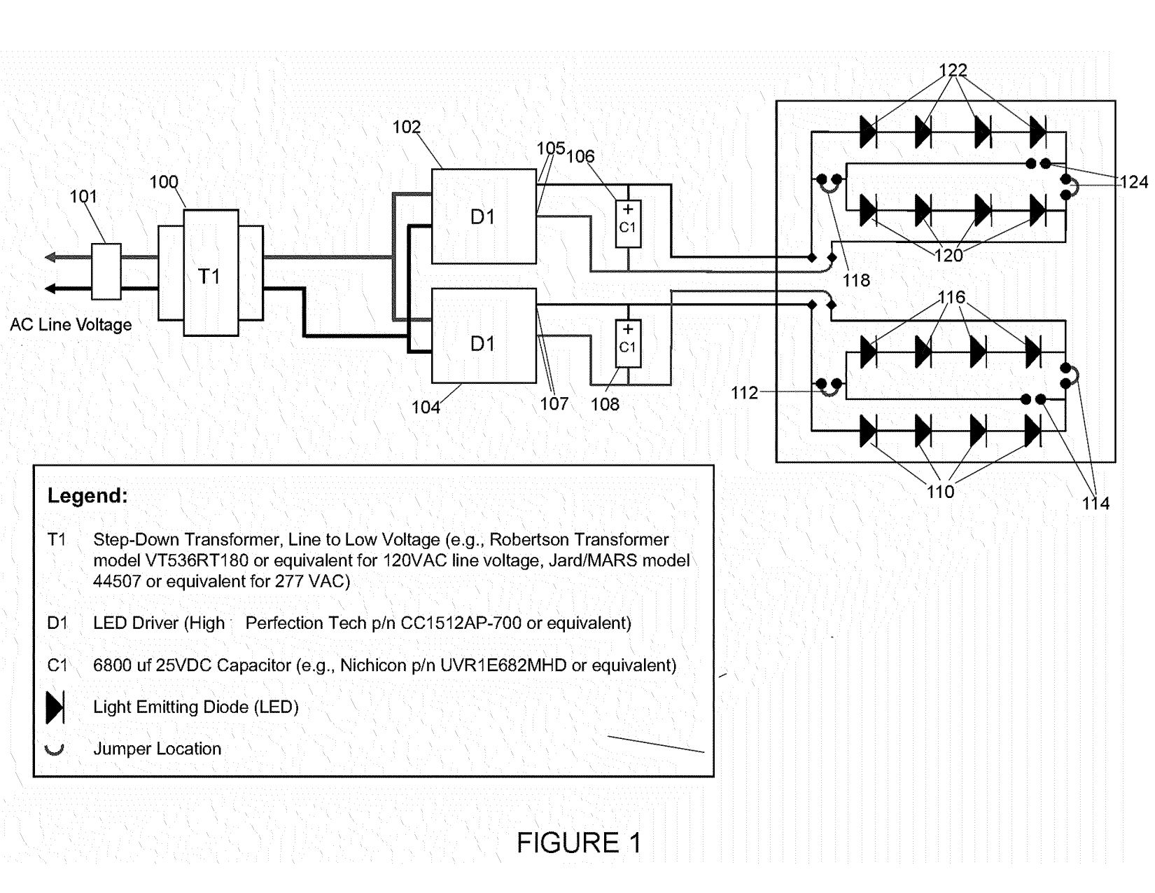

FIG. 1 is a circuit diagram illustrating an exemplary layout of a light dimmer circuit, according to an embodiment.

A dimmer 101 is connected to wires which are plugged into a standard 120V AC outlet. The dimmer 101 can a conventional incandescent dimmer, which utilizes a triac, such as Lutron Nova model N600, and outputs to a transformer 100. The dimmer 101 can be connected to a wall.

A step down transformer 100 receives the output from the dimmer 101. The step down transformer can be, for example, a Robertson Transformer model VT536RT180 for 120 VAC line voltage, or a Jard/MARS model 44507, or any other suitable transformer. The transformer can input 120V and lower it to 24V (or other values as well such as 18) which can provide DC voltage at 700 milliamp driving current.

The step down transformer 100 can be connected to a first LED driver 102 and a second LED driver 104, connected as shown. The LED drivers can be, for example, a High Perfection Tech p/n CC1512AP-700, or any other suitable LED driver. The first LED driver 102 drives a first pair of driver terminals 105. The second LED driver 104 drives a second pair of driver terminals 107.

The first LED driver 102 is connected to a first capacitor 106 at the first pair of driver terminals 105, as illustrated. The first capacitor can be, for example, a 6800 uf 25 VDC capacitor (e.g., Nichia p/n UVR1E682MHD), or any other suitable capacitor. A wide range of capacitance values can be used as well and 6800 uf is just one example. The second LED driver 104 is connected to a second capacitor 108 at the second pair of driver terminals 107, as illustrated. The second capacitor can be, for example, a 6800 uf 25 VDC capacitor (e.g., Nichia p/n UVR1E682MHD), or any other suitable capacitor. A wide range of capacitance values can be used as well and 6800 uf is just one example. While the capacitance of the first capacitor 106 and the second capacitor 108 are equal, they do not necessarily have to be.

As the dimmer reduces the power output of the transformer 100, the drivers 102, 104 may not react quickly enough which can cause some flicker of the LEDs. Thus, the capacitors 106, 108 can maintain the current level while the drivers 102, 104 recover.

Point pairs 112, 114, 118, 124, can be used with jumpers in order to close the circuit between the respective points or leave it open. A first set of LEDs 110 connected in series and a second set of LEDs 116 connected in series are configured as illustrated. A third set of LEDs 120 connected in series and a fourth set of LEDS 122 connected in series are configured as illustrated. A strand of eight LEDs can use about 15.8 volts, but this can vary according to the LED manufacturer.

Jumpers can be placed at an of the point pairs. Thus, as one skilled in the art would appreciate, strands of powered LEDs for each driver can comprise either 0 LEDS, 4 LEDs, 8 LEDs, depending on how the jumpers are configured.

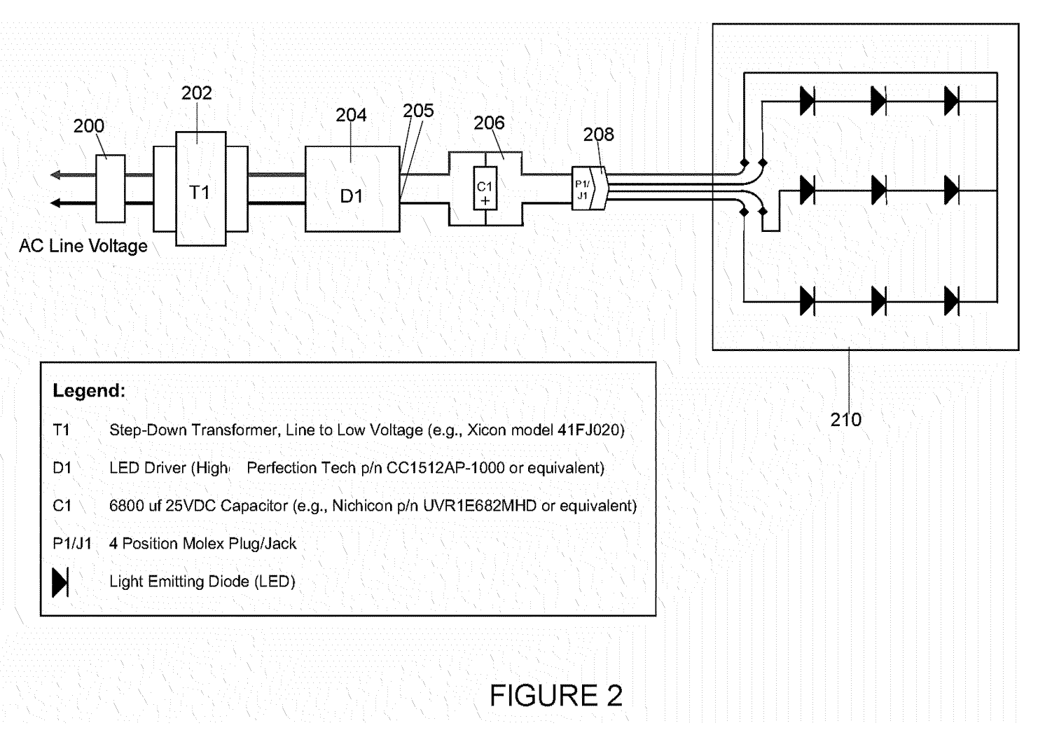

In a further embodiment, instead of using a pair of drivers, a single driver can be used. FIG. 2 is a circuit diagram illustrating a second layout of a light dimmer circuit, according to an embodiment.

A dimmer 200 is connected to wires which are plugged into a standard 120V AC outlet. The dimmer 200 can be a conventional incandescent dimmer, which utilizes a triac, such as Lutron Nova model N600, and outputs to a transformer 202. The dimmer 200 can be connected to a wall.

The transformer 202 can be a Step-Down Transformer, for example a line to low voltage (e.g., Xicon model 41FJ020).

The transformer 202 is connected to a LED driver 204. The LED driver can be, for example, a High Perfection Tech p/n CC1512AP-1000 or equivalent). The LED driver 204 outputs to a pair of driver terminals 205.

A capacitor 206 is connected in parallel to the pair of driver terminals 205 and also in series with a connector 208. The connector 208 can be, for example, a 4 position Molex plug/jack, which is then connected to strands of LEDs. Any number of LEDs (and strands) can be used. The capacitor 206 serves the same purpose as described in FIG. 1. The capacitor 206 can be a 6800 uf 25 VDC capacitor (e.g., Nichia p/n UVR1E682MHD or equivalent). Other capacitances can be used as well.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. An apparatus comprising:
a dimmer connected to a line voltage;
a transformer connected to an output of the dimmer;
a first LED driver connected to the transformer, the first LED driver having a first pair of driver terminals;
a first capacitor connected in parallel to the first pair of driver terminals;
a second LED driver connected to the transformer, the second LED driver having a second pair of driver terminals;
a second capacitor connected in parallel to the second pair of driver terminals;
a first string of LEDs connected in parallel to the first capacitor; and
a second string of LEDs connected in parallel to the second capacitor.

2. The apparatus as recited in claim 1, wherein the dimmer is a triac dimmer.

3. An apparatus comprising:
a dimmer connected to a line voltage;
a transformer connected to an output of the dimmer;
an LED driver connected to the transformer, the first LED driver having a pair of driver terminals;
a capacitor connected in parallel to the pair of driver terminals;
a connector connecting connected in parallel to the capacitor; and
a string of LEDs connected to the connector.

4. The apparatus as recited in claim 3, wherein the dimmer is a triac dimmer.
